(19) United States
(12) Patent Application Publication
(10) Pub. No.: US 2007/0103403 A1
(43) Pub. Date: May 10, 2007

(54) Plasma display device, driving apparatus and driving method thereof

(76) Inventors: Jin-Ho Yang, Yongin-si (KR); Woo-Joon Chung, Yongin-si (KR); Seong-Joon Jeong, Yongin-si (KR); Tae-Seong Kim, Yongin-si (KR); Suk-Jae Park, Yongi-si (KR)

Correspondence Address: LEE & MORSE, P.C., 3141 FAIRVIEW PARK DRIVE, SUITE 500, FALLS CHURCH, VA, 22042, US

(21) Appl. No.: 11/593,583

(22) Filed: Nov. 7, 2006

(30) Foreign Application Priority Data
Nov. 8, 2005 (KR) 10-2005-0106348

(51) Int. Cl. G09G 3/28

(52) U.S. Cl. 345/68

(57) ABSTRACT

A plasma display device includes a plurality of first electrodes and a plurality of second electrodes, the plurality of first and second electrodes adapted to generate a sustain discharge so as to display an image on a screen, a first inductor including a first end coupled to the plurality of first electrodes, a second inductor including a first end coupled to the plurality of first electrodes, the second inductor having an inductance that is less than an inductance of the first inductor, a first driving block adapted to control a voltage of the plurality of first electrodes through the first inductor, and a second driving block adapted to control the voltage of the plurality of first electrodes through the second inductor, the second driving block is located closer to a lower portion of a screen than the first driving block.

### BACKGROUND OF THE INVENTION

1. Field of the Invention

The present invention relates to a plasma display device, a driving apparatus and a driving method thereof. More particularly, the present invention relates to an energy recovery circuit of a plasma display device.

2. Description of the Related Art

A plasma display device is a flat panel display that uses plasma generated by a gas discharge process to display characters or images. In general, one frame of the plasma display device may be divided into a plurality of subfields so as to drive the plasma display device. Turn-on/off cells (i.e., cells to be turned on or off) may be selected during an address period of each subfield, and a sustain discharge operation may be performed on the turn-on cells so as to display an image during a sustain period.

During the sustain period, a high level voltage and a low level voltage may be alternately applied to each electrode on which the sustain discharge operation is performed. Since two electrodes on which the sustain discharge is generated may form a capacitor, a reactive power may be required for applying the high level and the low level voltages to the electrodes. Accordingly, an energy recovery circuit may be used in a sustain discharge circuit of the plasma display to recover and reuse reactive power. Such an energy recovery circuit may include a plurality of switches, an inductor, and a capacitor. However, a rated current may not be satisfied by employing one switch, and, therefore, the plurality of switches may be coupled in parallel and operated as one switch.

A plurality of switches respectively having different functions in an energy recovery circuit has been provided as a driving block, e.g., an intelligent power module (IPM). Therefore, a plurality of driving blocks may be coupled in parallel to the electrode so as achieve a rated current. However, heat deflection may occur in a driving block provided in an upper portion of the plasma display device, since it may be influenced by heat generated from the driving block itself, as well as heat generated from a lower portion of the plasma display device. As a result, elements included in the driving block provided in the upper portion of the plasma display device may be easily damaged.

The above information disclosed in this Background section is only for enhancement of understanding of the background of the invention and therefore it may contain information that does not constitute prior art that is already known in this country to a person of ordinary skill in the art.

### SUMMARY OF THE INVENTION

The present invention is therefore directed to a plasma display, a driving apparatus and a method thereof that substantially overcome one or more of the problems due to the limitations and disadvantages of the related art.

It is therefore a feature of an exemplary embodiment of the present invention to provide a plasma display device for controlling a plurality of driving blocks to generate a uniform amount of heat, and a driving apparatus and driving method thereof.

At least one of the above and other features and advantages of the present invention may be realized by providing a plasma display device which may include a plasma display panel (PDP) including a plurality of first electrodes and a plurality of second electrodes, the plurality of first and second electrodes adapted to generate a sustain discharge so as to display an image on a screen, a first inductor including a first end coupled to the plurality of first electrodes, a second inductor including a first end coupled to the plurality of first electrodes, the second inductor having an inductance that is less than an inductance of the first inductor, a first driving block adapted to control a voltage of the plurality of first electrodes through the first inductor, and a second driving block adapted to control the voltage of the plurality of first electrodes through the second inductor, the second driving block located closer to a lower portion of the screen than the first driving block.

The plasma display device may further include a third inductor, the third inductor including a first end coupled to the plurality of first electrodes, the third inductor having an inductance that is less than that of the first inductor and greater than that of the second inductor, and a third driving block adapted to control the voltage of the plurality of first electrodes together with the first and second driving blocks, wherein the third driving block is located closer to the lower portion of the screen than the first driving block and closer to an upper portion of the screen than the second driving block.

The first driving block may include a first switch coupled between a first power source and the plurality of first electrodes, the first power source adapted to supply a first voltage, a second switch coupled between a second power source and the plurality of first electrodes, the second power source adapted to supply a second voltage that is lower than the first voltage, a third switch coupled between a third power source and a second end of the first inductor, and forming a path for increasing a voltage of the first electrode, the third power source adapted to supply a third voltage that is between the first voltage and the second voltage, and a fourth switch coupled between the third power source and the second end of the first inductor, and forming a path for decreasing the voltage of the first electrode.

The first driving block may further include a first diode coupled to the third switch in series, and a second diode coupled to the fourth switch in series. The first diode and the second diode may be coupled to the second end of the first inductor.

The third power source may include a capacitor adapted to supply the third voltage, and the capacitor may be coupled to the third switch and the fourth switch.

The first driving block may be further adapted to increase the voltage of the first electrode by turning on the third switch during a first period, apply the first voltage to the first electrode by turning on the first switch during a second period, decrease the voltage of the first electrode by turning on the fourth switch during a third period, and apply the second voltage to the first electrode by turning on the second switch during a fourth period.

The plasma display device may further include a sustain discharge circuit adapted to apply the second voltage to the second electrode while the first voltage is applied to the first electrode through the first switch, and apply the first voltage to the second electrode while the second voltage is applied to the first electrode through the second switch. The second voltage may be ground.

The first and second driving blocks may respectively form an intelligent power module (IPM).

At least one of the above and other features and advantages of the present invention may be realized by providing a driving apparatus of a plasma display panel including first and second electrodes adapted to generate a sustain discharge, the driving apparatus may include at least one first inductor including a first end coupled to the first electrode, at least one second inductor including a first end coupled to the first electrode, the at least one second inductor having an inductance that is different from an inductance of the least one first inductor, a first driving block adapted to control a voltage of the first electrode through the at least one first inductor, and a second driving block adapted to control the voltage of the first electrode through the at least one second inductor.

The first driving block may be located closer to an upper portion of a screen of the plasma display device than the second driving block, and the at least one first inductor may have an inductance that is greater than an inductance of the at least one second inductor.

The at least one first inductor may include an inductor for increasing the voltage of the first electrode and an inductor for decreasing the voltage of the first electrode, and the at least one second inductor may include an inductor for increasing the voltage of the first electrode and an inductor for decreasing the voltage of the first electrode.

The first driving block may include a first switch coupled between a first power source and the first electrode, the first power source adapted to supply a first voltage, a second switch coupled between a second power source and the first electrode, the second power source adapted to supply a second voltage that is lower than the first voltage, a third switch coupled between a third power source and a second end of the first inductor, and forming a path for increasing a voltage of the first electrode, the third power source adapted to supply a third voltage that is between the first voltage and the second voltage, and a fourth switch coupled between the third power source and the second end of the first inductor, and forming a path for decreasing the voltage of the first electrode.

The first driving block may further include a first diode coupled to the third switch in series, and a second diode coupled to the fourth switch in series.

The first switch and the second switch may be coupled to the first ends of the at least one first inductor.

The first and the second driving blocks respectively form an intelligent power module (IPM).

At least one of the above and other features and advantages of the present invention may be realized by providing a method of driving a plasma display device, the plasma display device including a first electrode and a second electrode adapted to generate a sustain discharge, at least one first inductor and at least one second inductor, a first driving block adapted to control the voltage of the first electrode through the at least one first inductor, and a second driving block adapted to control the voltage of the first electrode through the at least one second inductor, the method may include control the first and second driving blocks to increase the voltage of the first electrode through the at least one first inductor and the at least one second inductor during a first period, applying a first voltage to the first electrode during a second period, control the first and second driving blocks to decrease the voltage of the first electrode through the at least one first inductor and the at least one second inductor during a third period, and applying a second voltage that is lower than the first voltage to the first electrode during a fourth period.

The method may include applying the second voltage to the second electrode to generate a sustain discharge during the second period, and applying the first voltage to the second electrode to generate a sustain discharge during the fourth period.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic diagram of a plasma display device according to an exemplary embodiment of the present invention.

FIG. 2 illustrates sustain pulses according to the exemplary embodiment of the present invention.

FIG. 3 illustrates a schematic circuit diagram of a sustain discharge circuit according to the exemplary embodiment of the present invention.

FIG. 4 illustrates a signal timing diagram of the sustain discharge circuit of FIG. 3.

FIG. 5 illustrates a schematic modeling of the sustain discharge circuit when a resonance is generated.

FIG. 6 and FIG. 7 respectively illustrate sustain pulses according to other exemplary embodiments of the present invention.

FIG. 8 illustrates a schematic circuit diagram of a sustain discharge circuit according to another exemplary embodiment of the present invention.

### DETAILED DESCRIPTION OF THE INVENTION

Korean Patent Application No. 10-2005-0106348 filed in the Korean Intellectual Property Office on Nov. 8, 2005, and entitled: “Plasma Display and Driving Device Thereof,” is incorporated by reference herein in its entirety.

The present invention will now be described more fully hereinafter with reference to the accompanying drawings, in which exemplary embodiments of the present invention are illustrated. The present invention may, however, be embodied in different forms and should not be construed as limited to the exemplary embodiments set forth herein. Rather, these exemplary embodiments are provided so that this disclosure will be thorough and complete, and will fully convey the scope of the invention to those skilled in the art.

Accordingly, the drawings and description are to be regarded as illustrative in nature and not restrictive. Like reference numerals designate like elements throughout the specification.

Throughout this specification and the claims which follow, when it is described that an element is coupled to another element, the element may be directly coupled to the other element or electrically coupled to the other element through a third element.

Unless explicitly described to the contrary, the word “comprises/includes” or variations such as “comprises/includes” or “comprising/including” will be understood to imply the inclusion of stated elements, but not the exclusion of any other elements.

When it is described in the specification that a voltage is maintained, it should not be understood to strictly imply that the voltage is maintained exactly at a predetermined voltage. To the contrary, even though a voltage difference between two points varies as time passes, the voltage difference is expressed to be maintained at a predetermined voltage in the case that the variance is within a range allowed in design constraints or in the case that the variance is caused due to a parasitic component that is usually disregarded by a person of ordinary skill in the art. In addition, since threshold voltages of semiconductor elements (e.g., a transistor and a diode) are relatively low compared to a discharge voltage, the threshold voltages may be approximated to 0 Volts (0V).

A plasma display device according to an exemplary embodiment of the present invention, and a driving apparatus and a driving method thereof, will now be described with reference to the accompanying drawings. According to the exemplary embodiments of the present invention, heat deflection in the driving block in the upper portion of the plasma display device may be avoided by controlling a plurality of driving blocks to generate a uniform amount of heat generation.

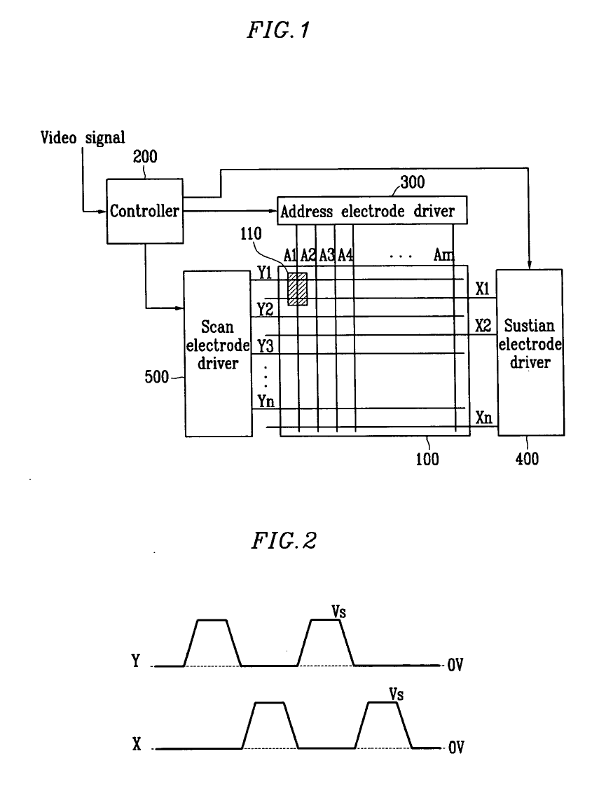

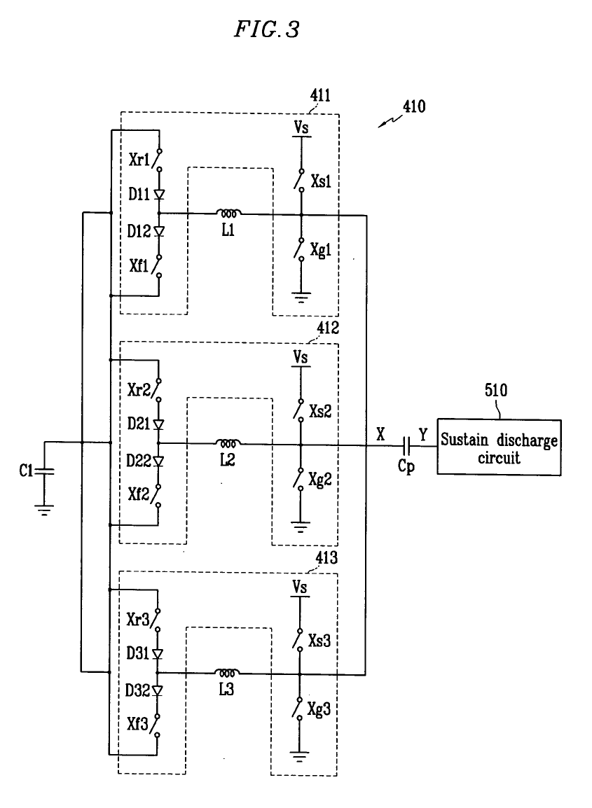

FIG. 1 illustrates a schematic diagram of a plasma display device according an exemplary embodiment of the present invention, and FIG. 2 illustrates a sustain pulse according to the exemplary embodiment of the present invention.

As illustrated in FIG. 1, the plasma display device according to the exemplary embodiment of the present invention may include a plasma display panel (PDP) 100, a controller 200, an address electrode driver 300, a sustain electrode driver 400, and a scan electrode driver 500. The controller 200 and the drivers 300, 400, and 500 may be on a chassis base (not illustrated) facing the PDP 100.

The PDP 100 may include a plurality of address electrodes A1 to Am (hereinafter referred to as “A electrodes”) extending in a column direction, and a plurality of sustain electrodes X1 to Xn (hereinafter referred to as “X electrodes”) and scan electrodes Y1 to Yn (hereinafter referred to as “Y electrodes”) extending in a row direction by pairs. In general, the X electrodes X1 to Xn respectively correspond to the Y electrodes Y1 to Yn, and the Y electrodes Y1 to Yn and the X electrodes X1 to Xn may be arranged to cross the A electrodes A1 to Am. A discharge space on a crossing region of the A electrodes A1 to Am and the X and Y electrodes X1 to Xn and Y1 to Yn may form a discharge cell 110. The PDP 100 may display an image by using a combination of discharge cells to be turned on among a plurality of the discharge cells 110.

The controller 200 may receive an external signal, such as a video signal, and may output a driving control signal, and may divide a frame into a plurality of subfields respectively having a brightness weight value, and may drive them. Each subfield may include an address period and a sustain period. The A electrode, the X electrode, and the Y electrode drivers 300, 400, and 500 respectively may apply a driving voltage to the A electrodes A1 to Am, the X electrodes X1 to Xn, and the Y electrodes Y1 to Yn, in response to driving control signals from the controller 200.

For example, during the address period of each subfield, the A electrode, the X electrode, and the Y electrode drivers 300, 400, and 500 may select the turn-on discharge cells and the turn-off discharge cells from among the plurality of discharge cells 110. During the address period of each subfield, as illustrated in FIG. 2, the X electrode driver 400 may apply a sustain pulse alternately having a high level voltage (Vs) and a low level voltage (0V) to the plurality of X electrodes X1 to Xn a number of times corresponding to a weight value of the corresponding subfield. The Y electrode driver 500 may apply the sustain pulse having a reverse phase of the sustain pulse applied to the X electrodes X1 to Xn, to the plurality of Y electrodes Y1 to Yn. Accordingly, a voltage difference between the Y electrodes and the X electrodes alternately becomes a voltage (Vs) and a voltage (−Vs), and the sustain discharge may be repeatedly generated on the turn-on discharge cell a predetermined number of times.

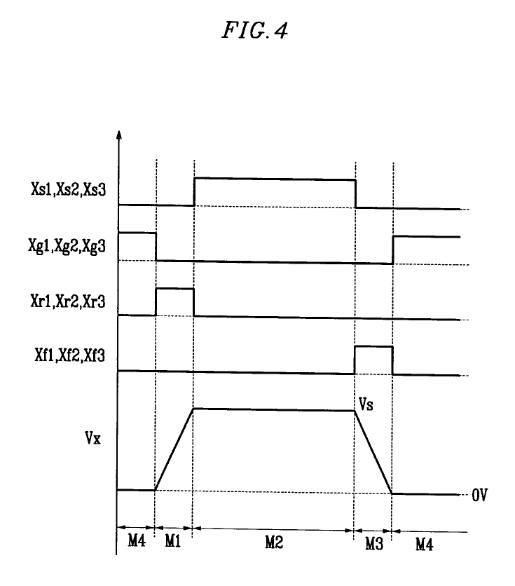

A sustain discharge circuit that supplies the sustain discharge pulse of FIG. 2 will now be described in more detail with reference to FIG. 3 to FIG. 5.

FIG. 3 illustrates a schematic circuit diagram of a sustain discharge circuit according to the exemplary embodiment of the present invention. In FIG. 3, the sustain discharge circuit 410 may be coupled to a plurality of X electrodes X1 to Xn. A sustain discharge circuit 510 coupled to the plurality of Y electrodes Y1 to Yn may have the same configuration as of the sustain discharge circuit 410 in FIG. 3. In addition, for better understanding and ease of description, one X electrode and one Y electrode are illustrated in the sustain discharge circuit 410, and a capacitance formed by the X electrode and Y electrode is illustrated as a panel capacitor Cp.

The sustain discharge circuit 410 may include a plurality of driving blocks, a plurality of inductors, and a capacitor used as a power unit for an energy recovery function. For better understanding and ease of description, FIG. 3 illustrates three driving blocks 411, 412, and 413, three inductors L1, L2, and L3, and a capacitor C1. In the sustain discharge circuit 410, the driving block 411 may be in an upper portion of the plasma display device, and the driving block 413 may be in a lower portion of the plasma display device. The driving block 412 may be between the driving blocks 411 and 413. That is, the upper portion may be an upper portion of a screen of the PDP 100 and the lower portion may be a lower portion of the screen of the PDP 100.

The plurality of driving blocks 411, 412, and 413 may be coupled to the X electrode in parallel, and first ends of the plurality of inductors L1, L2, and L3 may be coupled to the X electrode in parallel. Second ends of the inductors L1, L2, and L3 may be respectively coupled to the corresponding driving blocks 411, 412, and 413, and the driving blocks 411, 412, and 413 may be commonly coupled to the capacitor C1. However, a capacitor may be employed for each driving block, and, thus, a plurality of capacitors may be respectively coupled to the plurality of driving blocks 411, 412, and 413.

The driving block 411 may include a plurality of switches Xs1, Xg1, Xr1, and Xf1, and diodes D11 and D12. The switches Xs1, Xg1, Xr1, and Xf1 may be replaced with transistors.

The switch Xs1 may be coupled between a power source (Vs), which may supply a high level voltage (Vs) of the sustain pulse, and the X electrode. The switch Xg1 may be coupled between a power source (i.e., a ground terminal), which may supply a low level voltage (0V) of the sustain pulse, and the X electrode. A cathode of the diode D11 and an anode of the diode D12 may be coupled to a second end of the inductor L1. The switch Xr1 may be coupled between an anode of the diode D11 and the capacitor C1. The switch Xf1 may be coupled between a cathode of the diode D12 and the capacitor C1. The capacitor C1 may supply a voltage between the high level voltage (Vs) and the low level voltage (0V), and may provide a half voltage (Vs/2) of the two voltages (Vs) and (0V).

The diode D11 may establish a current path for increasing a voltage of the X electrode, and the diode D12 may establish a current path for decreasing the voltage of the X electrode. However, the location of the diode D11 and the location of the switch Xr1 may be reversed with each other, as well as the location of the diode D12 and the location of the switch Xf1.

Like the driving block 411, the driving block 412 may include switches Xs2, Xg2, Xr2, and Xf2, and diodes D21 and D22, and the driving block 413 may include switches Xs3, Xg3, Xr3, and Xf3, and diodes D31 and D32. The switches and the diodes of the driving blocks 412 and 413 may be coupled in the same way as the switches and the diodes of the driving block 411 are coupled.

The inductance of the inductor L1 coupled to the driving block 411 in the upper portion of the plasma display device may be greater than the inductance of the inductors L2 and L3 coupled to the driving blocks 412 and 413 in the lower portion of the plasma display device. The inductance of the inductor L2 coupled to the driving block 412 may be greater than the inductance of the inductor L3 coupled to the driving block 413.

An exemplary operation of the sustain discharge circuit of FIG. 3 will now be described in more detail with reference to FIG. 4. FIG. 4 illustrates a signal timing diagram of the sustain discharge circuit 410 of FIG. 3.

It will be assumed that switches Xg1, Xg2, and Xg3 may be turned on at a fourth mode M4 before a first mode M1 and the X electrode is applied with a low level voltage (0V).

As illustrated in FIG. 4, during a first mode M1, the switches Xr1, Xr2, and Xr3 may be turned on, and the switches Xg1, Xg2, and Xg3 may be turned off. Then, a resonance may be generated through a path of the capacitor C1, the switches Xr1, Xr2, and Xr3, the diodes D11, D21, and D31, the inductors L1, L2, and L3, and the panel capacitor Cp. Thus, a voltage Vx of the X electrode may be increased.

During a second mode M2, the switches Xs1, Xs2, and Xs3 may be turned on, and the switches Xr1, Xr2, and Xr3 may be turned off. Thus, the high level voltage (Vs) may be applied to the X electrode.

During a third mode M3, the switches Xf1, Xf2, and Xf3 may be turned on, and the switches Xs1, Xs2, and Xs3 may be turned off. Then, a resonance may be generated through a path of the panel capacitor Cp, the inductors L1, L2, and L3, the diodes D12, D22, and D32, the switches Xf1, Xf2, and Xf3, and the capacitor C1. Thus, the voltage Vx of the X electrode may be decreased.

Subsequently, during the fourth mode M4, the switches Xg1, Xg2, and Xg3 may be turned on, and the switches Xf1, Xf2, and Xf3 may be turned off. Thus, a low level voltage (0V) may be applied to the X electrode.

As discussed above, the sustain discharge circuit 410 according to the exemplary embodiment of the present invention may apply the sustain pulse alternately having the high level voltage (Vs) and the low level voltage (0V) to the X electrode, since the first to fourth modes M1 to M4 may be repeatedly performed a number of times corresponding to a weight value of the corresponding subfield during the sustain period. In addition, the sustain discharge circuit 510 of the Y electrode driver 500 may apply a sustain discharge pulse to the Y electrode by using the same circuit as in FIG. 3.

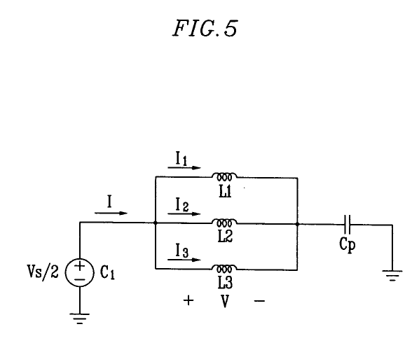

The driving blocks 411, 412, and 413 may generate heat during the resonance of the sustain discharge circuit 410. Thus, the driving block 413 in the lower portion of the plasma display device may receive cool air and spread heat such that the cool air received may be heated. The heated air may move to the driving block 412. The driving block 412 may receive the heated air from the driving block 413 and spread it, and the driving block 411 may receive more heated air from the driving block 412 and spread it. Even though it is assumed that all the driving blocks 411, 412, and 413 spread the same, the driving block 411 in the upper portion of the plasma display device may spread more heated air than the other driving blocks. Therefore, the heat spread of driving blocks L1, L2, and L3 may be controlled by setting the inductance of the inductors L1, L2, and L3 to be different from each other. This will be described with reference to FIG. 5.

FIG. 5 illustrates schematic modeling of the sustain discharge circuit 410 in the case that a resonance is generated.

As illustrated in FIG. 5, when a resonance is generated between the panel capacitor Cp and the inductors L1, L2, and L3, the inductors L1, L2, and L3 may be coupled to the X electrode of the capacitor Cp in parallel, and the capacitor C1 may be coupled to the second ends of the inductors L1, L2, and L3 as a power source. The total inductance of the inductors L1, L2, and L3 may be calculated by Equation 1.

$$L = \frac{{L}_{1} {L}_{2} {L}_{3}}{{L}_{1} {L}_{2} + {L}_{2} {L}_{3} + {L}_{3} {L}_{1}} \qquad [ Equation 1 ]$$

where L₁, L₂, and L₃ respectively denote the inductance of the respective inductors L1, L2, and L3.

In the case that currents I₁, I₂, and I₃ respectively flow to the inductors L1, L2, and L3, and the current I flows to all the inductors L1 to L3 coupled in parallel, a voltage V at lateral ends of the parallel-connected inductors L1, L2, and L3 may be calculated by Equation 2.

$$V = L \frac{ⅆ I}{ⅆ t} = {L}_{1} \frac{ⅆ {I}_{1}}{ⅆ t} = {L}_{2} \frac{ⅆ {I}_{2}}{ⅆ t} = {L}_{3} \frac{ⅆ {I}_{3}}{ⅆ t} . \qquad [ Equation 2 ]$$

A relationship between the inductance L, L₁, L₂, and L₃, and the current I, I₁, I₂, I₃ of Equation 2 may be defined as shown in Equation 3.
LI=L₁I₁=L₂I₂=L₃I₃ [Equation 3]

The currents I₁, I₂, and I₃ respectively flowing to the inductors L1, L2, and L3 in Equations 1 to 3 may be obtained by the following Equation 4, and the relationships between the currents I₁, I₂, and I₃ flowing to the inductors L1, L2, and L3, and the inductances L₁, L₂, and L₃ may be given by the following Equation 5.

$$\begin{matrix}{I}_{1} = \frac{L}{{L}_{1}} I = \frac{{L}_{2} {L}_{3}}{{L}_{1} {L}_{2} + {L}_{2} {L}_{3} + {L}_{3} {L}_{1}} I \\ {I}_{2} = \frac{L}{{L}_{2}} I = \frac{{L}_{1} {L}_{3}}{{L}_{1} {L}_{2} + {L}_{2} {L}_{3} + {L}_{3} {L}_{1}} I \\ {I}_{3} = \frac{L}{{L}_{3}} I = \frac{{L}_{1} {L}_{2}}{{L}_{1} {L}_{2} + {L}_{2} {L}_{3} + {L}_{3} {L}_{1}} I & [ Equation 4 ] \\ {I}_{1} \text{:} {I}_{2} \text{:} {I}_{3} = {L}_{2} {L}_{3} \text{:} {L}_{1} {L}_{3} \text{:} {L}_{1} {L}_{2} & [ Equation 5 ]\end{matrix}$$

Therefore, the inductance L1 of the inductor L1 may be set to be greater than the inductances L₂ and L₃ of the inductors L2 and L3 such that the current I₁ flowing to the switches Xr1 and Xf1 of the driving block 411 may be reduced compared to that of the currents I₂ and I₃ flowing to the switches Xr2, Xf2, Xr3, and Xf3 of the driving blocks 412 and 413. As a result, a conduction loss generated from the switches Xr1 and Xf1 of the driving block 411 may be reduced such that the amount of heat generation of the driving block 411 may be reduced compared to those of other driving blocks 412 and 413. Similarly, the amount of heat generation of the driving block 412 may be reduced compared to that of the driving block 413 in the lower portion of the plasma display device by setting the inductance L₂ of the inductor L2 to be greater than the inductance L₃ of the inductor L3. Therefore, temperature deviations due to the locations of the driving blocks 411, 412, and 413 may be reduced by setting the inductances L₁, L₂, L₃ of the inductors L1, L2, and L3 to be different from each other.

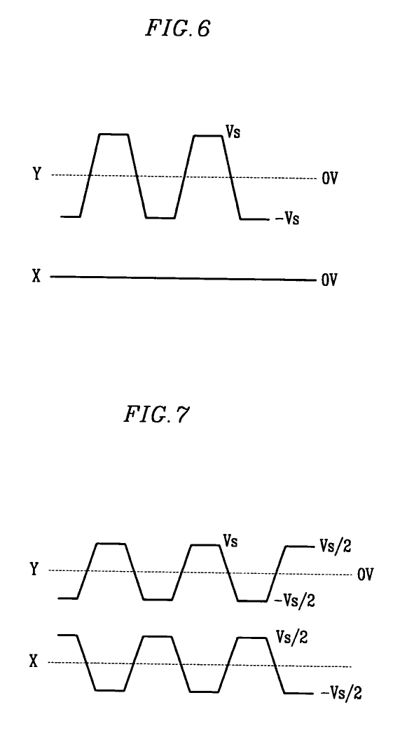

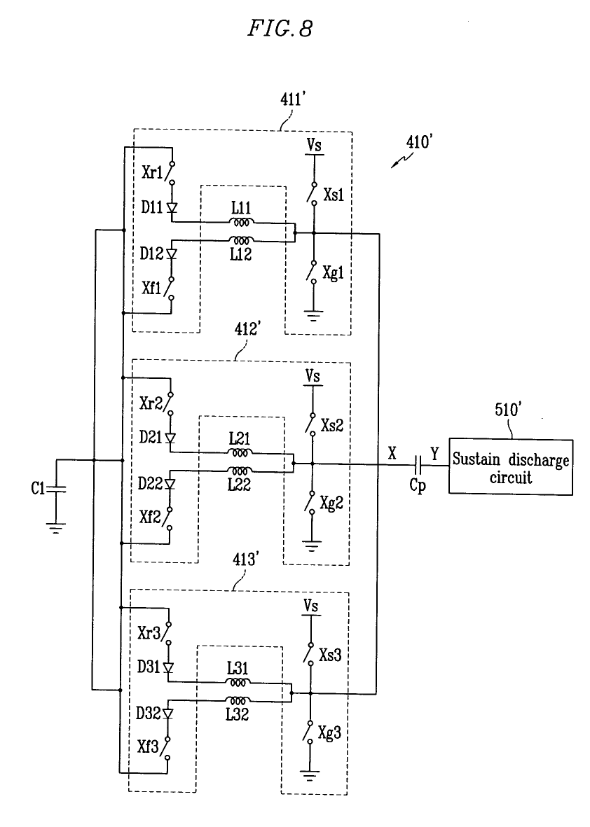

Even though the high level voltage and the low level voltage applied to the X and Y electrodes may be set to be voltage (Vs) and voltage (0V), respectively in the exemplary embodiment of the present invention, the high level voltage and the low level voltage may have voltage levels other than the voltage (Vs) and the voltage (0V). That is, a difference between the high level voltage applied to the X electrode and the low level voltage applied to the Y electrode may be set to be the voltage (Vs), and the low level voltage applied to the X electrode may be set to be the voltage (−Vs) of the high level voltage applied to the Y electrode. For example, as illustrated in FIG. 7, the high level voltage applied to the X electrode and the Y electrode may be set to a voltage (Vs/2), and the low level voltage applied to the X electrode and the Y electrode may be set to a voltage (−Vs/2). In addition, as illustrated in FIG. 6, one of the X electrode and the Y electrode may be applied with 0V, and the other electrode may be applied with a sustain discharge pulse alternately having the voltage (Vs) and the voltage (−Vs).

Although the path (hereinafter referred to as “increasing path”) for increasing the voltage of the X electrode and the path (hereinafter referred to as “decreasing path”) for decreasing the voltage of the X electrode may be employed by using one inductor L1 in the driving block 411 according to the exemplary embodiment of the present invention, the increasing path and the decreasing path may be respectively set to pass different inductors.

FIG. 8 illustrates a schematic circuit diagram of a sustain discharge circuit 410′ according to another exemplary embodiment of the present invention. Again, a sustain discharge circuit 510′ coupled to the plurality of electrodes may have the same configuration as the sustain discharge circuit 410′.

Referring to FIG. 8, in a driving block 411′, an inductor L11 may be the increasing path and an inductor L12 may be the decreasing path, by coupling the inductor L11 between the diode D11 and the X electrode, and by coupling the inductor L12 between the diode D12 and the X electrode. However, the locations of the inductor L11, the diode D11, and the switch Xr1 may be reversed with each other, and the locations of the inductors L12, the diode D12, and the switch Xf1 may also be reversed with each other. In like manner, in driving blocks 412′ and 413′, inductors L21 and L31 may be an increasing path, and inductors L22 and L32 may be a decreasing path.

The inductances of the inductors L11 and L12 coupled to the driving block 411′ may be set to be greater than those of the inductors L21, L22, L31, and L32 coupled to driving blocks 412′ and 413′.

As described above, according to the exemplary embodiments of the present invention, heat deflection in the driving block in the upper portion of the plasma display device may be avoided by controlling a plurality of driving blocks to generate a uniform amount of heat generation.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a plasma display panel (PDP) including a plurality of first electrodes and a plurality of second electrodes, the plurality of first and second electrodes adapted to generate a sustain discharge so as to display an image on a screen;
a first inductor including a first end coupled to the plurality of first electrodes;
a second inductor including a first end coupled to the plurality of first electrodes, the second inductor having an inductance that is less than an inductance of the first inductor;
a first driving block adapted to control a voltage of the plurality of first electrodes through the first inductor; and
a second driving block adapted to control the voltage of the plurality of first electrodes through the second inductor, wherein the second driving block is located closer to a lower portion of the screen than the first driving block.

2. The plasma display device as claimed in claim 1, further including:
a third inductor including a first end coupled to the plurality of first electrodes, the third inductor having an inductance that is less than that of the first inductor and greater than that of the second inductor; and
a third driving block adapted to control the voltage of the plurality of first electrodes together with the first and second driving blocks, wherein the third driving block is located closer to the lower portion of the screen than the first driving block and closer to an upper portion of the screen than the second driving block.

3. The plasma display device as claimed in claim 1, wherein the first driving block includes:
a first switch coupled between a first power source and the plurality of first electrodes, the first power source adapted to supply a first voltage;
a second switch coupled between a second power source and the plurality of first electrodes, the second power source adapted to supply a second voltage that is lower than the first voltage;
a third switch coupled between a third power source and a second end of the first inductor, and forming a path for increasing a voltage of the first electrode, the third power source adapted to supply a third voltage that is between the first voltage and the second voltage; and
a fourth switch coupled between the third power source and the second end of the first inductor, and forming a path for decreasing the voltage of the first electrode.

4. The plasma display device as claimed in claim 3, wherein the first driving block further includes:
a first diode coupled to the third switch in series; and
a second diode coupled to the fourth switch in series.

5. The plasma display device as claimed in claim 4, wherein the first diode and the second diode are coupled to the second end of the first inductor.

6. The plasma display device as claimed in claim 3, wherein the third power source includes a capacitor adapted to supply the third voltage, and the capacitor is coupled to the third switch and the fourth switch.

7. The plasma display device as claimed in claim 3, wherein the first driving block is further adapted to:
increase the voltage of the first electrode by turning on the third switch during a first period;
apply the first voltage to the first electrode by turning on the first switch during a second period;
decrease the voltage of the first electrode by turning on the fourth switch during a third period; and
apply the second voltage to the first electrode by turning on the second switch during a fourth period.

8. The plasma display device as claimed in claim 3, further including a sustain discharge circuit adapted to apply the second voltage to the second electrode while the first voltage is applied to the first electrode through the first switch, and apply the first voltage to the second electrode while the second voltage is applied to the first electrode through the second switch.

9. The plasma display device as claimed in claim 8, wherein the second voltage is ground.

10. The plasma display device as claimed in claim 1, wherein the first and the second driving blocks respectively form an intelligent power module (IPM).

11. A driving apparatus of a plasma display device including a first electrode and a second electrode, the first and second electrodes adapted to generate a sustain discharge, the driving apparatus comprising:
at least one first inductor including a first end coupled to the first electrode;
at least one second inductor including a first end coupled to the first electrode, the at least one second inductor having an inductance that is different from an inductance of the at least one first inductor;
a first driving block adapted to control a voltage of the first electrode through the at least one first inductor; and
a second driving block adapted to control the voltage of the first electrode through the at least one second inductor.

12. The driving apparatus as claimed in claim 11, wherein the first driving block is located closer to an upper portion of a screen of the plasma display device than the second driving block, and the at least one first inductor has an inductance that is greater than an inductance of the at least one second inductor.

13. The driving apparatus as claimed in claim 11, wherein the at least one first inductor includes an inductor for increasing the voltage of the first electrode and an inductor for decreasing the voltage of the first electrode, and the at least one second inductor includes an inductor for increasing the voltage of the first electrode and an inductor for decreasing the voltage of the first electrode.

14. The driving apparatus as claimed in claim 11, the first driving block including:
a first switch coupled between a first power source and the first electrode, the first power source adapted to supply a first voltage;
a second switch coupled between a second power source and the first electrode, the second power source adapted to supply a second voltage that is lower than the first voltage;
a third switch coupled between a third power source and a second end of the first inductor, and forming a path for increasing a voltage of the first electrode, the third power source adapted to supply a third voltage that is between the first voltage and the second voltage; and
a fourth switch coupled between the third power source and the second end of the first inductor, and forming a path for decreasing the voltage of the first electrode.

15. The driving apparatus as claimed in claim 14, wherein the first driving block further includes:
a first diode coupled to the third switch in series; and
a second diode coupled to the fourth switch in series.

16. The driving apparatus as claimed in claim 14, wherein the first driving block is further adapted to:
increase the voltage of the first electrode by turning on the third switch during a first period;
apply the first voltage to the first electrode by turning on the first switch during a second period;
decrease the voltage of the first electrode by turning on the fourth switch during a third period; and
apply the second voltage to the first electrode by turning on the second switch during a fourth period.

17. The driving apparatus as claimed in claim 11, wherein the first and the second driving blocks respectively form an intelligent power module (IPM).

18. A method of driving a plasma display device, the plasma display device including a first electrode and a second electrode adapted to generate a sustain discharge, at least one first inductor and at least one second inductor, a first driving block adapted to control the voltage of the first electrode through the at least one first inductor, and a second driving block adapted to control the voltage of the first electrode through the at least one second inductor, the method comprising:
control the first and second driving blocks to increase the voltage of the first electrode through the at least one first inductor and the at least one second inductor during a first period;
applying a first voltage to the first electrode during a second period;
control the first and second driving blocks to decrease the voltage of the first electrode through the at least one first inductor and the at least one second inductor during a third period; and
applying a second voltage that is lower than the first voltage to the first electrode during a fourth period,
wherein the at least one second inductor having an inductance that is different from an inductance of the at least one first conductor,
wherein the second driving block is closer to a lower portion of a screen of the plasma display device than the first driving block.

19. The method as claimed in claim 18, the method further comprising:
applying the second voltage to the second electrode to generate a sustain discharge during the second period; and
applying the first voltage to the second electrode to generate a sustain discharge during the fourth period.
